(19) United States
(12) Patent Application Publication
(10) Pub. No.: US 2015/0375600 A1
(43) Pub. Date: Dec. 31, 2015

(54) ELECTRIC HEATER FOR VEHICLE HEATING CIRCUIT

(71) Applicant: VALEO SYSTEMES THERMIQUES, Le Mesnil Saint-denis (FR)

(72) Inventors: Frédéric Pierron, Rambouillet (FR); Laurent Tellier, Paris (FR); Jose Leborgne, Elancourt (FR)

(73) Assignee: Valeo Systemes Thermiques, Le Mesnil Saint Denis (FR)

(21) Appl. No.: 14/769,624

(22) PCT Filed: Feb. 28, 2014
(86) PCT No.: PCT/EP2014/054001

§ 371 Date: Aug. 21, 2015

(30) Foreign Application Priority Data
Feb. 28, 2013 (FR) 1351773

(51) Int. Cl. B60H 1/22; H05B 3/02; H05B 3/06; H05B 3/00

(52) U.S. Cl. CPC B60H 1/2221; H05B 3/0014; H05B 3/026; H05B 3/06

(57) ABSTRACT

The invention relates to a motor vehicle heating system comprising a heating circuit (1) containing a heat-transfer liquid, this heater (9) comprising a fluid inlet (11) and a first fluid outlet (12) and a second fluid outlet (13), and means (16, 17) for electrically heating the heat-transfer liquid and for distributing this heating in a controlled manner between the heat-transfer liquid proceeding to the first outlet (12) and the heat-transfer liquid proceeding to the second outlet (13), the first and second outlets (12, 13) being intended to be connected respectively to a first and to a second radiator (3, 4) of the heating circuit, in order to heat these two radiators (3, 4) to different temperatures.

The invention relates to an electric heater with which, for example, a motor vehicle heating circuit which contains a heat-exchange fluid and, for example, a heat-exchange liquid is intended to be provided.

Such an electric heater allows the passenger space of an electric or hybrid vehicle to be heated, by heating the heat-exchange liquid of the heating circuit of this vehicle using the Joule effect, this circuit incorporating a radiator in order to dissipate into the passenger space the heat provided by the heater.

The radiator of this heating circuit comprises a left-hand portion and a right-hand portion which are dedicated to the heating of the left-hand portion and the right-hand portion of the passenger space, respectively, in the knowledge that, in practice, the radiator extends at one side and the other of a wall which separates the left-hand portion from the right-hand portion thereof.

In a complementary manner, a mixing flap is provided in order to adjust the temperature of the left-hand portion of the passenger space, by adjusting, for the air injected at the left-hand portion of the passenger space, the proportion of external air and air heated by the left-hand portion of the radiator. In a similar manner, another mixing flap enables the temperature of the right-hand portion of the passenger space to be adjusted.

An object of the invention is to provide another solution for heating at least two zones, for example, the left-hand portion and the right-hand portion of the passenger space, to different temperatures.

To this end, the invention relates to an electric heater for a motor vehicle heating circuit which contains a heat-exchange liquid, this heater comprising a fluid inlet and a first fluid outlet and a second fluid outlet and means for electrically heating the heat-exchange liquid and for distributing in a controlled manner this heating between the heat-exchange liquid directed to the first outlet and the heat-exchange liquid directed to the second outlet, the first and the second outlet being intended to be connected to a first and a second radiator of the heating circuit, respectively, in order to heat these two radiators which are, for example, separate, to different temperatures.

With this solution, it is directly the heater which distributes the heat which is diffused to different portions of the passenger space by means of radiators which are dedicated to each passenger space portion so that it is no longer necessary to provide mixing flaps in order to separately adjust the temperature of two portions of the passenger space.

The invention also relates to a heater as defined above, comprising a first heating member and a second heating member which are separate and which are arranged so as to each receive a portion of the heat-exchange liquid introduced via the inlet and an electronic power card in order to supply electrical power to these heating members by distributing in a controlled manner the power introduced into each heating member, the first and second heating members having their outlets connected to the first and second outlet of the heater, respectively.

The invention also relates to a motor vehicle heating system comprising a heating circuit which contains a heat-exchange liquid, this heating circuit being provided with a first and a second radiator in order to diffuse the heat to two separate regions of the passenger space of the vehicle, and an electric heater as defined above, the first and the second fluid outlet of the heater being connected to the first and second radiator, respectively, the outlets of the first and second radiator being jointly connected to the inlet of the heater.

The invention also relates to a system as defined above, in which the two radiators are integrated in the same heat diffusion member.

According to one possible feature, the first and second radiators of the heating system form a radiator in one piece.

According to another possible feature, the first and second radiators of the heating system are separated from each other by a wall.

The wall which separates the first and the second radiator, which is, for example, athermic (or adiabatic) enables heat transfers between the radiators to be limited (or even enables the radiators to be at least partially thermally insulated from each other).

According to another possible feature, the heat diffusion member comprises at least one outlet which is connected, on the one hand, to the outlets of the first and second radiators, and, on the other hand, to the inlet of the heater.

According to another possible feature, the heat diffusion member of the heating system comprises two outlets which are connected to the outlets of the first and second radiators, respectively.

According to another possible feature, the first and second radiators are integrated in heat diffusion members which are separate from each other.

In this manner, the heat diffusion members which are dedicated to the diffusion of heat in the passenger space of the vehicle may be mounted close to the zones in which it is desirable to diffuse heat.

The invention will be better understood, and other objectives, details features and advantages thereof will be appreciated more clearly, from the following description of a specific embodiment of the invention, given purely by way of non-limiting example, with reference to the appended drawings, in which:

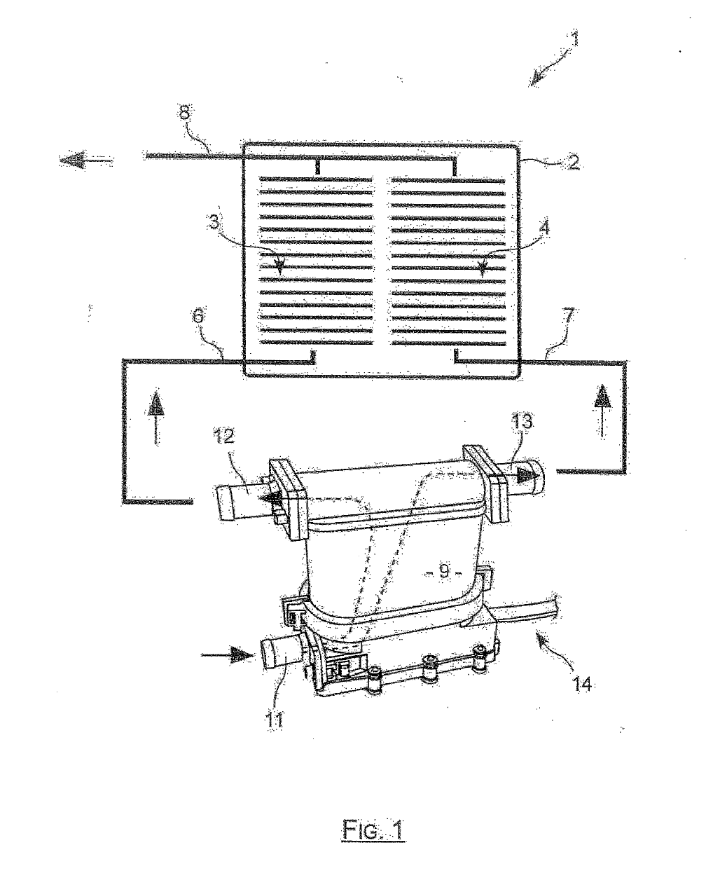

FIG. 1 is a partial, schematic view of a heating system which incorporates a heater according to the invention;

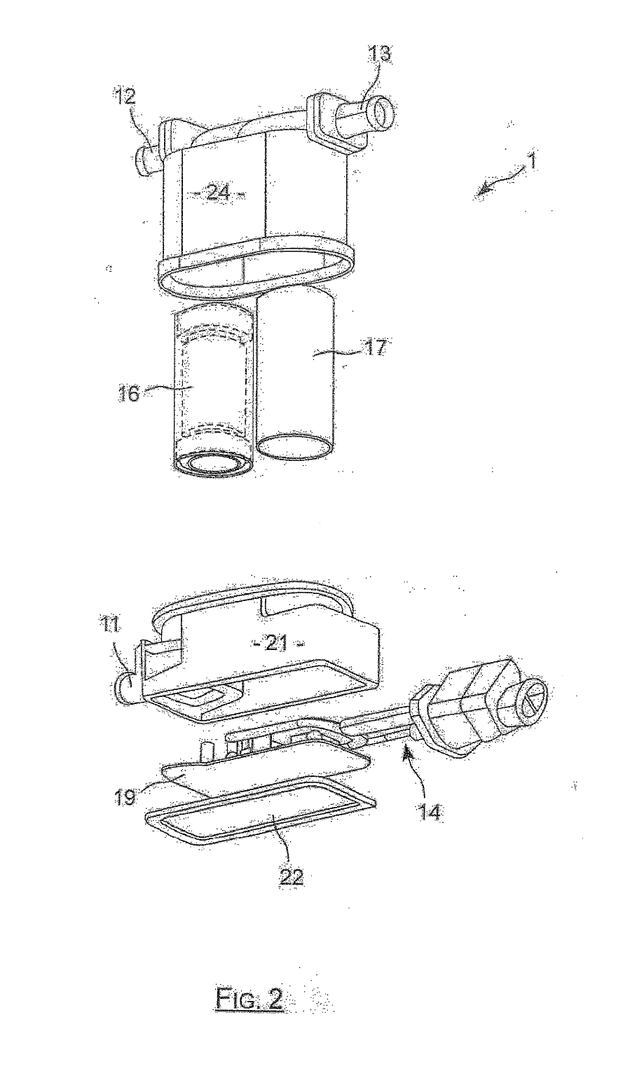

FIG. 2 is an exploded, perspective view of the heater of FIG. 1;

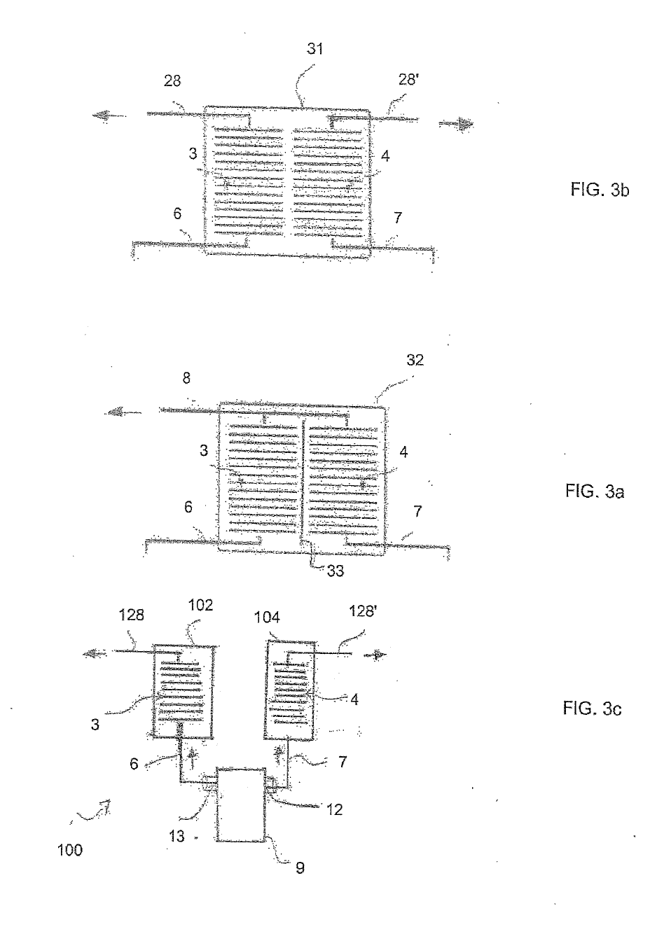

FIGS. 3a to 3c are schematic views of construction variants of a heating system according to the invention.

The notion on which the invention is based is to provide for the heating circuit one and the same member which jointly ensures the heating and the distribution of the heat of a heat-exchange fluid, and more particularly a heat-exchange liquid, which is directed towards two separate radiators of the heating circuit, in order to adjust in accordance with two set temperatures two zones of the vehicle, for example, the left-hand portion and the right-hand portion of the passenger space.

The heating system which is illustrated in FIG. 1 comprises a heating circuit 1 and a central member 2 which contains in this instance two separate radiators 3 and 4 which are dedicated to diffusing the heat towards two zones of the passenger space of the vehicle, respectively, for example, the left-hand portion and the right-hand portion of the passenger space which is provided with this heating system.

These radiators 3 and 4 are in this instance part of a central member 2 which is mounted at the front of the vehicle and which is dedicated to the diffusion of heat in the passenger space so that these two radiators 3 and 4 simply have the appearance of a single radiator. Each radiator 3, 4 comprises its own inlet, these inlets being designated 6 and 7, respectively, and the outlets of these two radiators are, for example, combined in one and the same outlet designated 8.

It should be noted that, in a construction variant which is not illustrated, the first radiator 3 and second radiator 4 may form a radiator which is in one piece (or even monobloc).

This assembly is supplied with heat-exchange liquid via an electric heater 9 which comprises a fluid inlet 11 (for example, single), and two separate outlets 12 and 13 which are connected to the inlet 6 and to the outlet 7 via tubes of the heating system, respectively. It should be noted that the first and second separate radiators 3 and 4 may further be separated from each other by a wall 33, for example, an athermic wall (this construction variant is more specifically illustrated in FIG. 3a).

The outlet 8 of the member 2 which combines the outlets of the radiators 3 and 4 is itself connected to the inlet 11 of the heater 9. Other components of the circuit 1 which are not illustrated, such as, for example, a cooling element, may where applicable be interposed between the outlet 8 of the radiators and the inlet 11 of the heater 9.

The heater 9 is controlled and electrically supplied via cables 14 which are connected, on the one hand, to an electrical power supply source of the vehicle and, on the other hand, to a control unit which is not illustrated. This electric heater 9 incorporates means for heating the fluid which it receives at the inlet 11 thereof and for distributing the thermal power for heating in a controlled manner, between the fluid which is directed to the first outlet 12 thereof and the fluid which is directed to the second outlet 13 thereof.

In other words, this heater 9 is capable of supplying at the outlet 12 a fluid which is at a temperature which is different from the fluid which it supplies in the region of the outlet 13 thereof.

In the embodiment illustrated in FIGS. 1 and 2, this heater 9 comprises at the inner side of the housing thereof two heating elements 16 and 17 using the Joule effect and an electronic power circuit 19 which supplies electrical power to these two heating elements 16 and 17, from the electrical power and the control instructions received on the cables 14.

As can be seen in FIG. 2, the housing comprises a housing base 21 which incorporates the inlet 11 and the introduction of the cables 14 and which constitutes a casing which contains in a substantially sealed manner the electronic power card 19, this lower portion being closed by a lower cap 22.

The fluid which is introduced via the inlet 11 engages in two channels which cannot be seen in the Figures but which are produced in an upper region of the base of the housing 21, in order to constitute two separate flows of fluid. These two flows of fluid pass through the heating elements 16 and 17 in a parallel manner, respectively, in order to be heated differently. This is because the electronic card 19 supplies the two heating elements 16 and 17 which are substantially identical with different powers, in accordance with control instructions that this electronic card 19 receives from a control unit which is not illustrated.

The fluid which is heated by the heating element 16 is discharged toward the outlet 12 in order to supply the first radiator 3, whilst the fluid which is heated by the heating element 17 is discharged toward the outlet 13 in order to supply the second radiator 4.

The base of the housing 21 is closed by an upper housing portion 24 which contains the elements 16 and and which comprises the outlets 12 and 13, this upper portion 24 which constitutes a cap closing the upper portion of the base of the housing 21.

As can be seen in particular in FIG. 1, the invention enables the simplification of the architecture of the circuit of a heating system of an electric or hybrid vehicle, ensuring the heating of two portions of the vehicle at two different set temperatures.

Furthermore, in a construction variant which is illustrated very schematically in FIG. 3b, a heat diffusion member 31 comprises a plurality of outlets which are connected to at least one of the outlets of the radiators 3 and 4.

The plurality of outlets of the member 31 are, for example, capable of being combined in a single conduit (not illustrated) which is connected to the inlet 11 of the heater 9.

More particularly, the member 31 comprises two outlets 28 and 28′ which are connected to the outlets of the radiators 3 and 4, respectively. The two outlets of the member 31 are, for example, arranged on opposing sides of the member 31.

In another construction variant which is illustrated very schematically in FIG. 3c, a heating system 100 comprises an electric heater 9 as defined above. The first and second fluid outlets 12 and 13 of the electric heater 9 are connected to the inlets of the radiators 3 and 4, respectively. The radiators 3 and 4 themselves are integrated in a first heat diffusion member 102 and a second heat diffusion member 104, respectively.

The first heat diffusion member 102 and second heat diffusion member 104 are separate from each other and may be mounted at different locations of the vehicle.

It is thus possible, during the configuration and/or assembly of the vehicle, to more readily include the heating system 100 according to the invention in the vehicle.

Furthermore, each of the members 102 and 104 comprises at least one outlet which is designated 128 and 128′, respectively, and which is connected to the outlet of the radiators 3 and 4, respectively.

1. An electric heater for a motor vehicle heating circuit which contains a heat-exchange liquid, this heater comprising:
a fluid inlet and a first fluid outlet and a second fluid outlet; and
means for electrically heating the heat-exchange liquid and for distributing in a controlled manner the heating between the heat-exchange liquid directed to the first outlet and the heat-exchange liquid directed to the second outlet,
the first and the second outlet being configured to be connected to a first and a second radiator of the heating circuit, respectively, in order to heat these two radiators to different temperatures.

2. The heater as claimed in claim 1, further comprising a first heating member and a second heating member which are separate, each heating member being configured to receive a portion of the heat-exchange liquid introduced via the inlet and an electronic power card in order to supply electrical power to these heating members by distributing in a controlled manner the power introduced into each heating member, the first and second heating members having their outlets connected to the first and second outlet of the heater, respectively.

3. A motor vehicle heating system comprising:
a heating circuit which contains a heat-exchange liquid, this heating circuit being provided with a first and a second radiator in order to diffuse the heat to two separate regions of the passenger space of the vehicle; and
an electric heater as defined in claim 1,
the first and the second fluid outlet of the heater being connected to the first and second radiator, respectively, the outlets of the first and second radiator being jointly connected to the inlet of the heater.

4. The system as claimed in claim 3, wherein the first and second radiators form a radiator in one piece.

5. The system as claimed in claim 3, wherein the first and second radiators are separated from each other by a wall.

6. The system as claimed in claim 3, wherein the two radiators are integrated in the same heat diffusion member.

7. The system as claimed in claim 6, wherein the heat diffusion member comprises at least one outlet which is connected to the outlets of the first and second radiators.

8. The system as claimed in claim 7, wherein the heat diffusion member comprises two outlets which are connected to the outlets of the first and second radiators, respectively.

9. The system as claimed in claim 3, wherein the first and second radiators are integrated in heat diffusion members which are separate from each other.
